(19) United States
(12) Patent Application Publication
(10) Pub. No.: US 2011/0242478 A1
(43) Pub. Date: Oct. 6, 2011

(54) LIQUID CRYSTAL FILTER, RETARDATION FILM, AND OPTICAL LOW-PASS FILTER

(75) Inventors: Kenichi YAKUSHIJI, Niigata (JP); Kazuhiro URA, Niigata (JP); Shozo MORIMOTO, Niigata (JP)

(73) Assignee: ARISAWA MFG. CO., LTD., Niigata (JP)

(21) Appl. No.: 13/162,556

(22) Filed: Jun. 16, 2011

Related U.S. Application Data
(63) Continuation of application No. PCT/JP2008/073257, filed on Dec. 19, 2008.

(51) Int. Cl. G02F 1/1333

(52) U.S. Cl. 349/193

(57) ABSTRACT

A liquid crystal filter made of a plurality of region having different liquid crystal molecule arrangement directions has a problem that linear defects, which are visible at boundaries between different liquid crystal molecule arrangement directions, are captured by image capturing elements. Therefore, provided is a liquid crystal filter comprising a first region that includes liquid crystals arranged in a first direction; a second region that includes liquid crystals arranged in a second direction, which is different from the first direction; and a buffer region that is disposed between the first region and the second region, and includes liquid crystals arranged in an intermediate direction between the first direction and the second direction.

The contents of the following International patent application are incorporated herein by reference: No. PCT/JP2008/073257 filed on Dec. 19, 2008.

### BACKGROUND

1. Technical Field

The present invention relates to a liquid crystal filter, a retardation film, and an optical low-pass filter.

2. Related Art

A liquid crystal filter is used as an optical component that utilizes the optical anisotropy of liquid crystal. The liquid crystal optical anisotropy is a phenomenon caused by different refractive indices between the long axis (late-phase axis) and the short axis (early-phase axis) of liquid crystal. As such liquid crystal filters, a retardation film that polarizes light and an optical low-pass filter that separates light are known.

A half-wave plate and a quarter-wave plate are examples of such a retardation film. Furthermore, a retardation film has many uses, and can be used in a stereoscopic image display apparatus. The retardation film used in a stereoscopic image display apparatus has a plurality of liquid crystal regions with prescribed arrangement directions lined up alternately in bands.

A low-pass filter, on the other hand, is used in a digital movie or a digital camera having image capturing elements, in order to prevent Moire fringes caused by the input of optical images that have spatial frequencies greater than the pixel pitch of the image capturing elements. Currently, most of the material used for optical low-pass filter is crystal plates that utilize birefringence. However, crystal plates are expensive and easy accumulate static charge, which makes dust a problem. Therefore, the use of liquid crystal filters is being investigated, as shown in International Publication WO 2008/004570, for example.

In an optical low-pass filter using a liquid crystal filter, there are filters that utilize birefringence in the same manner as crystal plates, and there are also filters that utilize first order diffracted light emitted with a prescribed angular separation by a latticework of liquid crystal regions having prescribed arrangement directions.

However, a stereoscopic image display apparatus or a liquid crystal filter utilizing first order diffracted light is made of a plurality of liquid crystal regions with different arrangements, and therefore shadows of the interfaces between liquid crystal regions are visible as linear defects. These linear defects lower the quality of the stereoscopic image display apparatus and are captured by the image capturing elements.

### SUMMARY

In order to solve the above problems, a liquid crystal filter according to an aspect of the present invention includes a liquid crystal filter comprising a first region that includes liquid crystals arranged in a first direction; a second region that includes liquid crystals arranged in a second direction, which is different from the first direction; and a buffer region that is disposed between the first region and the second region, and includes liquid crystals arranged in an intermediate direction between the first direction and the second direction.

The summary clause does not necessarily describe all necessary features of the embodiments of the present invention. The present invention may also be a sub-combination of the features described above.

### BRIEF DESCRIPTION OF THE DRAWINGS

FIG. 1A is a schematic view of a liquid crystal filter formed of optical low-pass filters and used in a digital camera or the like, as seen from the front.

FIG. 1B is a schematic view of the cross section over the line A-A in FIG. 1A.

FIG. 2 shows index ellipsoids in the liquid crystal filter.

FIG. 3 is a front view of an experimental liquid crystal filter in which two regions having different crystal arrangement directions are adjacent to each other.

FIG. 4A is a schematic view showing an example in which linear defects are visible.

FIG. 4B is a schematic view showing an example in which linear defects are not visible.

FIG. 5 is a diagram for describing an experiment.

FIG. 6A is a schematic view showing an example in which a buffer region formed of narrow rectangles is provided.

FIG. 6B is a schematic view showing an example in which a continuously changing buffer region is provided.

FIG. 6C is a schematic view showing an example in which another continuously changing buffer region is provided.

FIG. 7 shows an arrangement of liquid crystal molecules of a manufactured liquid crystal filter 600.

FIG. 8A is a diagram for describing the exposure of the first region 601.

FIG. 8B is a diagram for describing the exposure of the second region 602.

FIG. 9 shows the arrangement of the liquid crystal molecules in the manufactured liquid crystal filter 700.

FIG. 10A is a diagram for describing the exposure of the first region 701.

FIG. 10B is a diagram for describing the exposure of the narrow rectangular region 703.

FIG. 11 shows an exemplary configuration of an optical low-pass filter in which the liquid crystal molecule arrangement direction changes in a stepped manner.

FIG. 12 shows a configuration of an optical low-pass filter in which the liquid crystal molecule arrangement direction changes continuously.

FIG. 13 is a schematic view showing a configuration of a liquid crystal stereoscopic image display apparatus.

FIG. 14 shows a configuration of the retardation film in which the liquid crystal molecule arrangement directions changed in a stepped manner.

FIG. 15 shows a configuration of a retardation film in which the liquid crystal molecule arrangement direction changes continuously.

### DESCRIPTION OF EXEMPLARY EMBODIMENTS

Hereinafter, some embodiments of the present invention will be described. The embodiments do not limit the invention according to the claims, and all the combinations of the features described in the embodiments are not necessarily essential to means provided by aspects of the invention.

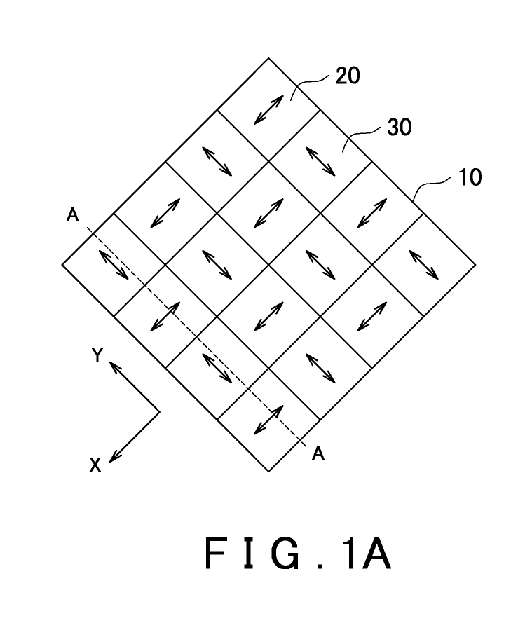

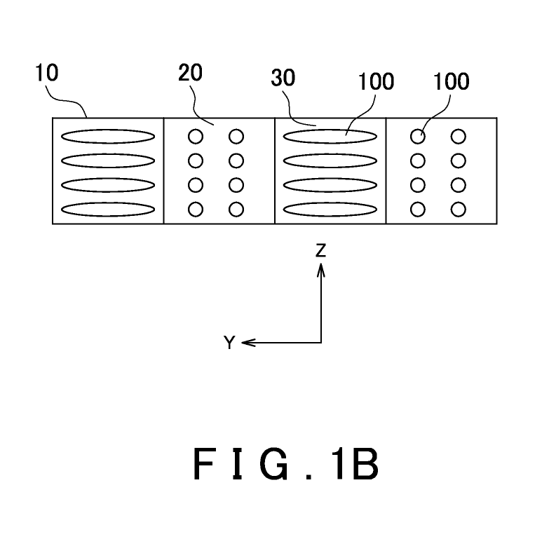

FIG. 1A is a schematic view of a liquid crystal filter formed of optical low-pass filters and used in a digital camera or the like, as seen from the front. The liquid crystal filter is divided into regions in a checkerboard pattern, as shown in FIG. 1A, in which liquid crystal molecules are arranged in the x-direction and the y-direction indicated by the arrows in FIG. 1A. FIG. 1B is a schematic view of the cross section over the line A-A in FIG. 1A. The liquid crystal molecules 100 function as uniaxial index ellipsoids. In a first region 20 of the liquid crystal filter 10, the liquid crystal molecules 100, i.e. the index ellipsoids, are arranged in the x-direction, which is a first direction. Similarly, in a second region 30, the index ellipsoids are arranged in the y-direction, which is a second direction differing from the first direction. The liquid crystal filter 10 was formed using a photopolymerizable liquid crystal composition including these liquid crystal molecules 100.

The liquid crystal filter 10 is hardened by infrared rays, and the liquid crystal molecules 100 are hardened in the arrangement shown by the cross-sectional view of FIG. 1B. In FIG. 1B, the liquid crystal molecules 100 are arranged in a plane parallel to a substrate surface, which is the xy-plane. In other words, the liquid crystal molecules 100 in the first region 20 are arranged in the x-direction and are substantially parallel to the substrate surface. Furthermore, the liquid crystal molecules 100 in the second region 30 are arranged in the y-direction and are also substantially parallel to the substrate surface. Therefore, the liquid crystal molecules 100 in the first region 20 and the liquid crystal molecules 100 in the second region 30 are orthogonal to each other in a plane parallel to the substrate surface. In FIG. 1B, the liquid crystal molecules 100 are shown as being parallel to the substrate surface, but the liquid crystal molecules 100 may instead be inclined with respect to the substrate surface. The liquid crystal molecules 100 have the optical anisotropic characteristics of uniaxial index ellipsoids. Accordingly, the direction in which the liquid crystal molecules 100 are arranged approximately matches the direction in which the index ellipsoids are arranged.

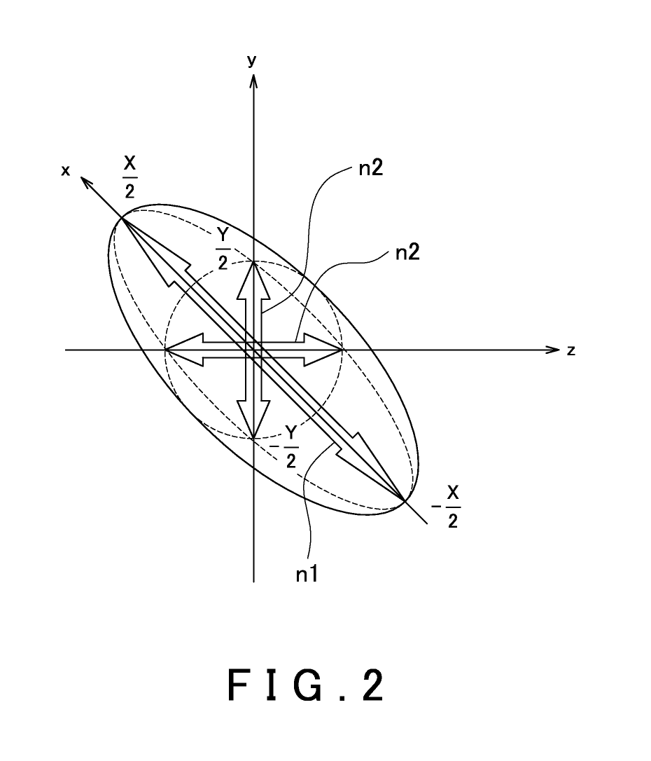

FIG. 2 shows the index ellipsoids in the liquid crystal filter. Each index ellipsoid is a rotating indicatrix shaped as an ellipse in the xy-plane with a long axis in an X direction and a short axis in a Y direction, and rotating on the x-axis. Furthermore, n1 in the x-direction represents the extraordinary refractive index, and n2 in the y-direction and n2 in the z-direction represent the ordinary refractive index. The relation between these refractive indices is such that n1>n2. The long axis of each index ellipsoid in the first region 20 in FIG. 1B is in the x-direction. The long axis of each index ellipsoid in the second region 30 is in the y-direction.

The following describes the behavior of light incident to the liquid crystal filter described above. In FIGS. 1A and 1B, an example is shown in which the light resulting in a combination of the polarized light vibrating in the x-direction and the polarized light vibrating in the y-direction, which is orthogonal thereto, is incident from the negative z-direction. With respect to the polarized light vibrating in the x-direction, the liquid crystal filter 10 has a refractive index of n1 in the first region 20 and a refractive index of n2 in the second region 30, and therefore functions as a diffraction grating. Similarly, with respect to the polarized light vibrating in the y-direction, the liquid crystal filter 10 has a refractive index of n2 in the first region 20 and a refractive index of n1 in the second region 30, and therefore functions as a diffraction grating. In other words, the liquid crystal filter functions as a diffraction grating regardless of the polarization direction of the light incident thereto. The liquid crystal filter 10 can exhibit the desired optical characteristics by arranging regions in which the liquid crystal molecules have different arrangement directions adjacent to each other.

However, at the interfaces between regions with different liquid crystal arrangement directions, wrap-around of the light used for exposure or the like during manufacturing, which is described further below, can cause linear defects under certain conditions. In the example of the diffraction grating used above, since the arrangement direction of the liquid crystal molecules 100 in the first region 20 is the x-direction and the arrangement direction of the liquid crystal molecules 100 in the second region 30 is the y-direction in the cross-sectional view of FIG. 1B, the arrangement directions at the interfaces differ by 90°. When there is a difference of 90°, linear defects occur at the interface.

These linearity defects can cause a drop in the image quality of optical devices using this liquid crystal filter. The liquid crystal filter is arranged immediately in front of an image capturing element, which is a CCD or CMOS sensor. When there are linear defects in this liquid crystal filter, the shadows of these defects are projected on the image capturing elements, and therefore appear in the image data as defects superimposed on the subject.

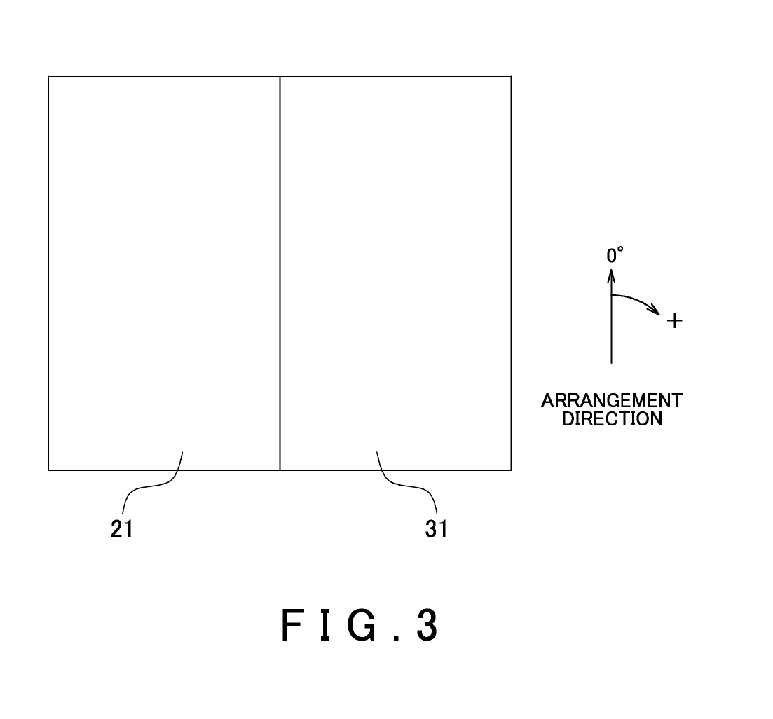

Concerning the occurrence of the linear defects, experimentation was performed to determine the visibility of interfaces appearing as linear shadows due to differences in the arrangement direction angle between liquid crystal molecules in adjacent regions. FIG. 3 is a front view of an experimental liquid crystal filter in which two regions having different crystal arrangement directions are adjacent to each other. This experiment involved manufacturing a plurality of experimental filters that each had different prescribed relative angles between the liquid crystal arrangement directions in an A region 21 and a B region 31, and observing linear defects at the interfaces using the naked eye. The direction toward the top of FIG. 3 corresponds to an arrangement direction of 0°, and the clockwise direction corresponds to positive angles. Table 1 shows the results of this experiment.

TABLE 1

| | | | ARRANGEMENT | |
|---|---|---|---|---|
| | ARRANGEMENT | ARRANGEMENT | DIRECTION | |
| | DIRECTION IN | DIRECTION IN | ANGLE | INTERFACE |
| | A REGION 21 | B REGION 31 | DIFFERENCE | VISIBILITY |
| EXPERIMENT | −45° | 45° | 90° | x |
| 1 | | | | |
| EXPERIMENT | 0° | 45° | 45° | Δ |
| 2 | | | | |
| EXPERIMENT | 30° | 45° | 15° | ∘ |
| 3 | | | | |
| (EXPERIMENT | 0° | 0° | 0° | ∘ |
| 4) | | | | |

X: Visible
Δ: Slightly visible
∘: Not visible

Based on the results of Table 1, it can be seen that linear defects are slightly visible when the liquid crystal arrangement directions of adjacent regions differ by 45° and that linear defects are practically invisible when the liquid crystal arrangement directions of adjacent regions differ by 15° or less. In this experiment, a photopolymerizable liquid crystal composition was used as the liquid crystal, and the observed results can change depending on the characteristics of the liquid crystal used. Therefore, an allowable angular difference between arrangement directions can be obtained by performing this experiment concerning visibility for each material.

It can be deduced from the experimental results that, when a first region and a second region having significantly different liquid crystal arrangement directions are adjacent to each other in the liquid crystal filter, the visibility of linear defects can be eliminated by inserting, at the interface therebetween, a region in which the arrangement directional changes gradually or in a stepped manner from the first direction, which is the arrangement direction in the first region, to the second direction, which is the arrangement direction in the second region. In other words, disposing a buffer region at the interface, such that the arrangement direction does not change suddenly, is effective for eliminating the visibility of linear defects.

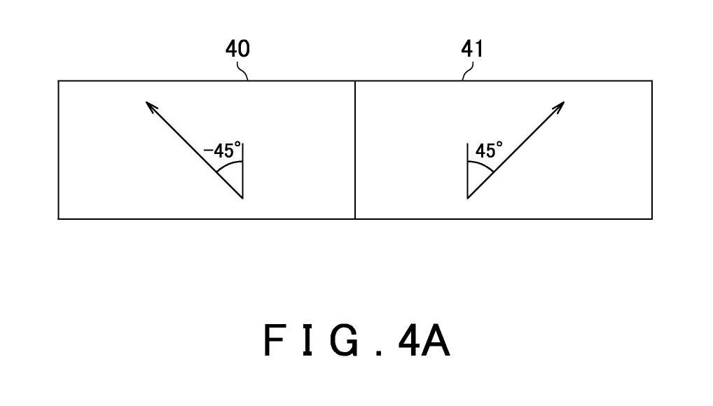

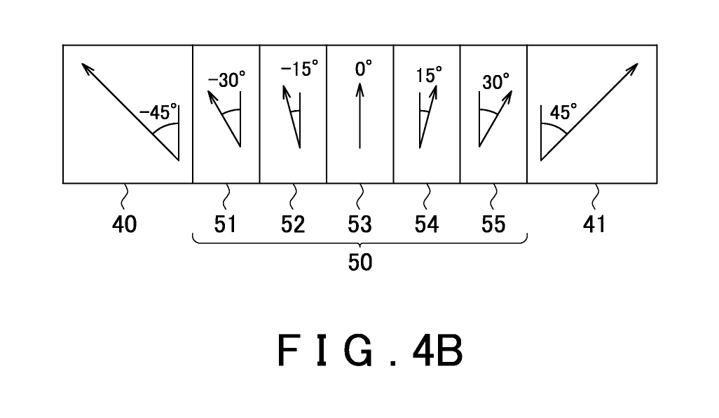

FIG. 4A is a schematic view showing an example in which linear defects are visible. FIG. 4B is a schematic view showing an example in which linear defects are not visible. Both of these examples show a liquid crystal filter including, as regions realizing the effects of the liquid crystal filter, a first region 40 in which the arrangement direction of the liquid crystal molecules is −45° and a second region 41 in which the arrangement direction of the liquid crystal molecules is 45°. As shown in FIG. 4A, when the first region 40 and the second region 41 are directly adjacent to each other, the angular difference between arrangement directions is 90°, and therefore, based on the experimental results of Table 1, it is known that linear defects are visible at the interface. FIG. 4B shows an example in which a buffer region 50 is disposed between the first region 40 and the second region 41. More specifically, the five narrow rectangular regions 51, 52, 53, 54, and 55 having respective liquid crystal molecule arrangement directions of −30°, −15°, 0°, 15°, and 30° are disposed between the first region 40 and the second region 41 in the stated order, beginning from the first region 40 side. In this case, in the seven regions including the first region 40, the second region 41, and the five regions described above, the angular difference between the arrangement directions of each pair of adjacent regions is 15°. Therefore, based on the experimental results of FIG. 1, it is known that linear defects are not visible between the first region 40 and the second region 41. In this experiment, confirmation concerning visibility was obtained by a method using two polarizing plates.

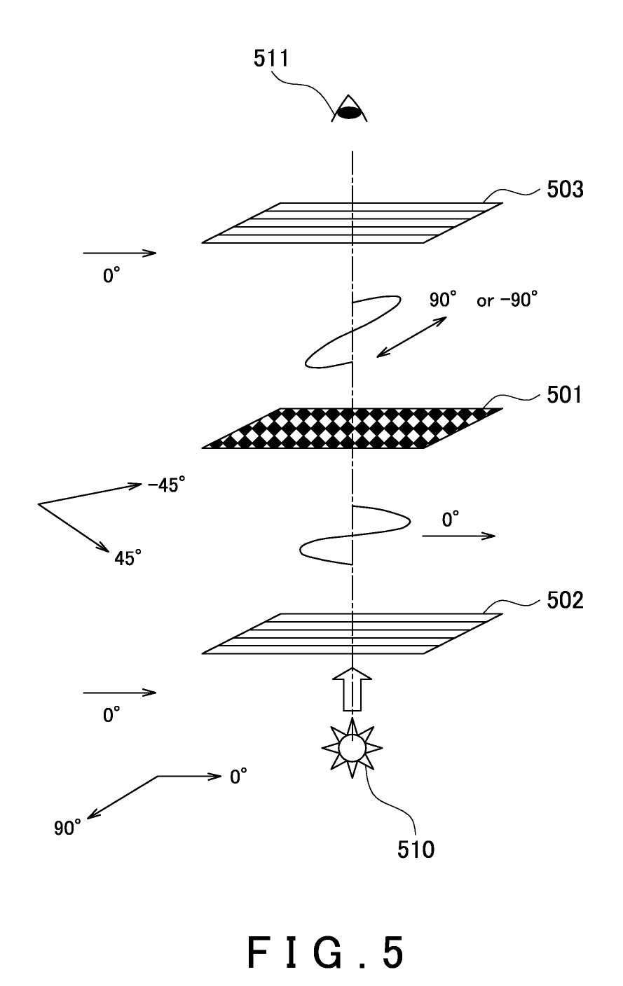

FIG. 5 is a diagram for describing the experiment. An experimental liquid crystal filter 501, which has a half-wave plate in this case, is sandwiched between polarizing plates 502 and 503. Light from a light source 510 provided below the experimental liquid crystal filter 501 passes therethrough, and is observed by an observer 511 using a microscope. Here, the orientation of the polarizing plate 502 is described in a plane in which the 0° direction is horizontally to the right and a clockwise direction as seen from above is a positive direction. The polarizing plates 502 and 503 are arranged in a manner to transmit polarized light whose vibrational direction is 0°. The polarized light with a vibrational direction of 0° is input to the experimental liquid crystal filter 501 by the polarizing plate 502 on the light source 510 side. In FIG. 5, the experimental liquid crystal filter 501 includes two regions with respective liquid crystal molecule arrangement directions of 45° and −45°. When 0° polarized light is incident to the 45° region, because of the half-wave plate, the polarized light is emitted with a vibrational direction of 90°. Similarly, when 0° polarized light is incident to the −45° region, because of the half-wave plate, the polarized light is emitted with a vibrational direction of −90°. The polarizing plate 503 on the observer 511 side blocks polarized light with vibrational directions of 90° and −90°. Up to this point in the description, the observer 511 sees only blackness, but the experimental liquid crystal filter 501, in the same manner as in the actual liquid crystal filter, has its own wavelength dispersion characteristics, and therefore light with certain wavelengths is passed. Accordingly, the regions with arrangement directions of 45° and −45° appear as relatively dark colors, while the linear defects at the interface appear relatively white.

In the example of FIG. 5, the liquid crystal molecule arrangement directions in the experimental liquid crystal filter 501 are 45° and −45°, and therefore the polarizing plates 502 and 503 are both oriented to transmit polarized light having a vibrational direction of 0°. When observing an experimental liquid crystal filter in which the arrangement directions are not 45° and −45°, the polarizing plates may be oriented according to one of the liquid crystal molecule arrangement directions. With this setting, the region with the arrangement direction that the setting is based on appears as a relatively dark color, and therefore the region where linear defects caused by the interface occur can be seen with a high degree of contrast.

The width of the buffer region 50 inserted in the interface between the first region 40 and the second region 41 is preferably as small as possible. Specifically, the first region 40 and the second region 41 realizing the characteristics of the liquid crystal filter are determined according to design requirements, and it is often the case that these regions are more efficient the wider they are. The following describes a specific method for decreasing the width of the buffer region 50.

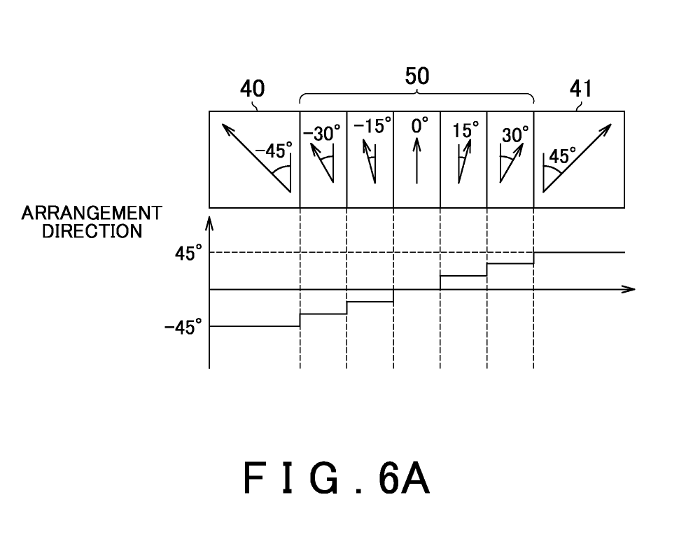

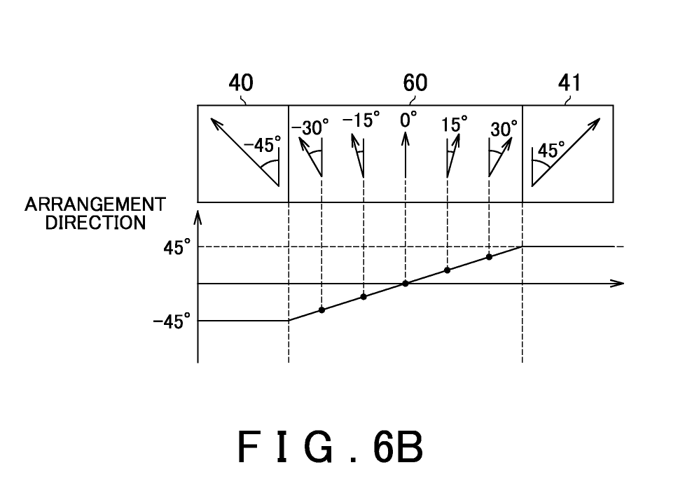

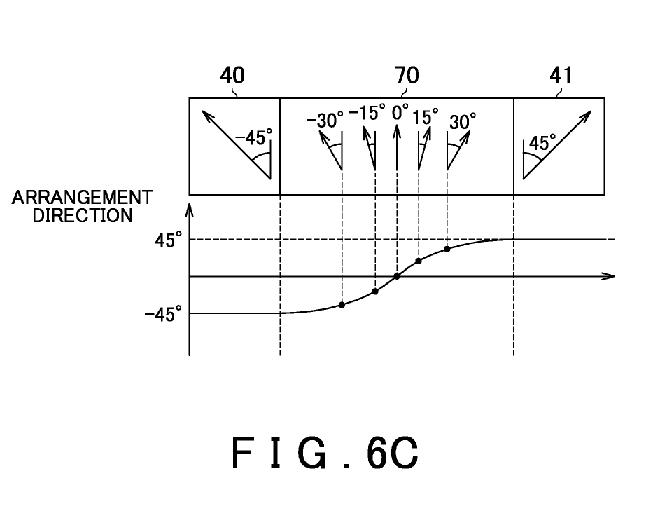

FIG. 6A is a schematic view showing an example in which a buffer region formed of narrow rectangles is provided. FIG. 6B is a schematic view showing an example in which a continuously changing buffer region is provided. FIG. 6C is a schematic view showing an example in which another continuously changing buffer region is provided. FIGS. 6A to 6C each show a front view of the liquid crystal filter in the upper portion thereof and show, in the lower portion thereof, a graph in which the arrangement direction of the liquid crystal molecules at positions corresponding to the positions in the upper portion is represented as an angle on the vertical axis.

The liquid crystal filter shown in FIG. 6A has the same configuration as the liquid crystal filter described in relation to FIG. 4B, in which five narrow rectangular regions are provided as the buffer region 50 between the first region 40 and the second region 41, thereby changing the liquid crystal molecule arrangement direction from −45° to 45° in steps of 15°.

The liquid crystal filter shown in FIG. 6B is not divided into narrow rectangular regions, and instead has a single buffer region 60 in which the liquid crystal molecule arrangement direction changes continuously. Specifically, the liquid crystal molecules are arranged such that the direction thereof changes continuously from −45° to 45°, from the interface with the first region 40 to the interface with the second region 41. As shown in the lower portion of FIG. 6B, the arrangement direction changes at a constant linear rate. Since the arrangement direction changes continuously, the linear defects occurring at the interfaces are expected to be even harder to see. In other words, the width of the buffer region 60 can be decreased as long as this liquid crystal filter can ensure the same visibility state as the liquid crystal filter shown in FIG. 6A. Even though FIG. 6B shows the buffer region 60 as having the same width as the buffer region 50 of FIG. 6A, the width of the buffer region 60 may be narrower.

In the liquid crystal filter shown in FIG. 6C, the liquid crystal molecule arrangement direction changes continuously from −45° to 45° from the interface with the first region 40 to the interface with the second region 41, in the same manner as in the liquid crystal filter of FIG. 6B, but with a change rate that is continuously changing. As shown in FIG. 6C, in the buffer region 70, the regions near the arrangement directions of −30° and 30° have relatively larger widths than the region near the arrangement direction of 0°, for example. In other words, as shown in FIG. 6C, the liquid crystal molecule arrangement direction changes in a manner to form a curve that has a greater change rate farther from the interfaces. With this configuration, there is a smooth transition to the interfaces with the first region 40 and the second region 41, and the width of the buffer region 70 can be determined according to the visibility characteristics. Therefore, linear defects are harder to see and the width of the buffer region 70 can be decreased. Even though FIG. 6C shows the buffer region 70 as having the same width as the buffer region 50 of FIG. 6A, the width of the buffer region 70 may be narrower. With the liquid crystal filter shown in FIG. 6A as well, the widths of the five narrow rectangular regions may be decreased such that the narrow rectangular regions farther from the boundaries are narrowed more. The regions in which the liquid crystal molecule arrangement direction changes linearly or continuously can be formed by setting very small rectangular regions and gradually changing the arrangement direction in each region, and a specific manufacturing method is described below.

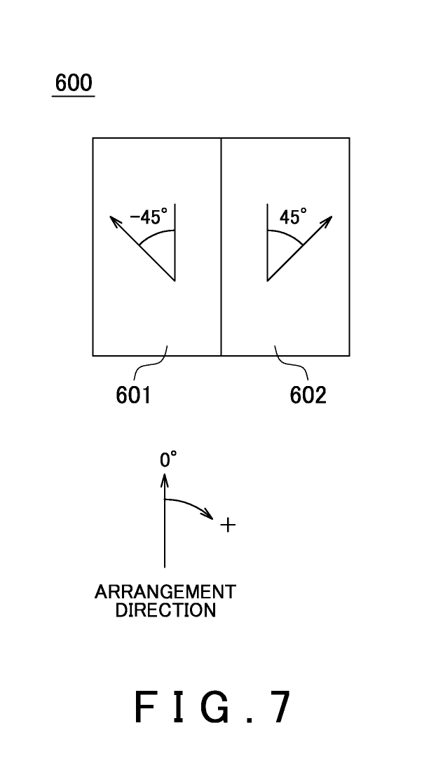

First, a manufacturing method of a liquid crystal filter in which regions with different arrangement directions are adjacent to each other will be described. FIG. 7 shows an arrangement of liquid crystal molecules of a manufactured liquid crystal filter 600. In the liquid crystal filter 600, the arrangement direction in the first region 601 on the left side is −45° and the arrangement direction in the second region 602 on the right side is 45°. The arrangement direction is defined by a plane in which a direction straight up in FIG. 7 is 0° and clockwise movement is in the positive direction.

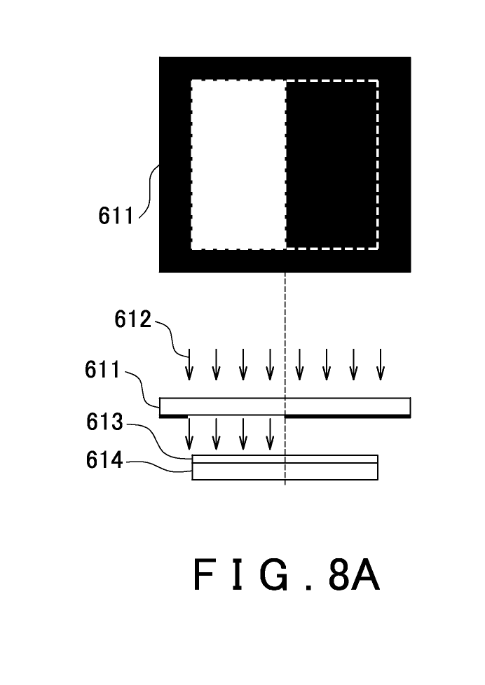

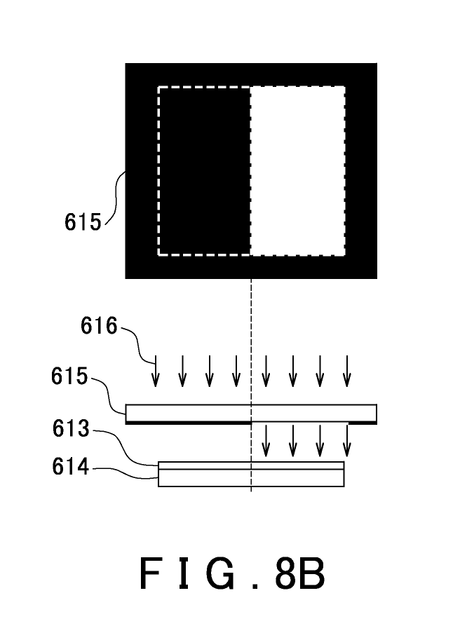

FIG. 8A is a diagram for describing the exposure of the first region 601. FIG. 8B is a diagram for describing the exposure of the second region 602. Prior to the exposure, the glass substrate 614 is coated with an orienting agent using a spin coater, and an appropriate amount of drying is performed to form the orientation film 613. The orientation film has a restraining force that causes the arrangement direction of the liquid crystal molecules that are applied later to have a direction parallel to or orthogonal to the polarization direction when exposed to polarized light. The orientation film 613 has a restraining force that causes the liquid crystals applied later to be lined up in a direction parallel to the polarization direction. Generally, an orientation film is sensitive to UV rays, and so the UV rays are used for the exposure. The following description uses UV rays as the light for the exposure.

The orientation film 613, which is appropriately dried, is exposed using a proximity technique by a UV polarized light exposure device while using a mask. First, as shown in FIG. 8A, a mask 611 with an open left half is used to perform exposure with polarized light 612 having a vibrational direction of −45°. Next, as shown in FIG. 8B, a mask 615 with an open right half is used to perform exposure with polarized light 616 having a vibrational direction of 45°. In this way, the left half of the orientation film 613 corresponding to the first region 601 has a restraining force in a −45° direction with respect to the liquid crystal molecules, and the right half of the orientation film 613 corresponding to the second region 602 has a restraining force in a 45° direction with respect to the liquid crystal molecules.

The glass substrate 614 on which the orientation film 613 is formed is coated with a photopolymerizable liquid crystal composition using a spin coater. The liquid crystal molecules in the photopolymerizable liquid crystal composition are arranged in prescribed directions according to the restraining force of the orientation film. Specifically, the liquid crystal molecules are arranged in the −45° direction in the left half of the orientation film 613 corresponding to the first region 601 and are arranged in the 45° direction in the right half of the orientation film 613 corresponding to the second region 602. Finally, the liquid crystal film is hardened by UV rays. The resulting liquid crystal filter includes liquid crystal molecules that have different arrangement directions in each of a plurality of regions on the glass substrate 614. In this example, the region with an arrangement direction of −45° and the region with an arrangement direction of 45° are adjacent to each other, and therefore linear defects can be seen at the interface.

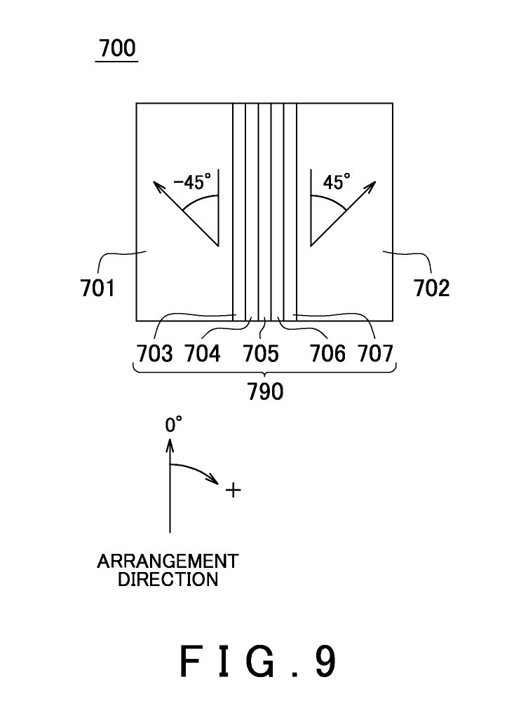

The following describes a manufacturing method of a liquid crystal filter that includes a buffer region formed of narrow rectangles at the interface and in which linear defects are not visible. FIG. 9 shows the arrangement of the liquid crystal molecules in the manufactured liquid crystal filter 700. In the liquid crystal filter, the first region 701 on the left side has an arrangement direction of −45°, the second region 702 on the right side has an arrangement direction of 45°, and a buffer region 790 is formed at the interface therebetween. The buffer region 790 is divided into narrow rectangular regions 703, 704, 705, 706, and 707, which have respective liquid crystal molecule arrangement directions of −30°, −15°, 0°, 15°, and 30°. The direction toward the top of FIG. 9 corresponds to an arrangement direction of 0°, and the clockwise direction corresponds to positive angles.

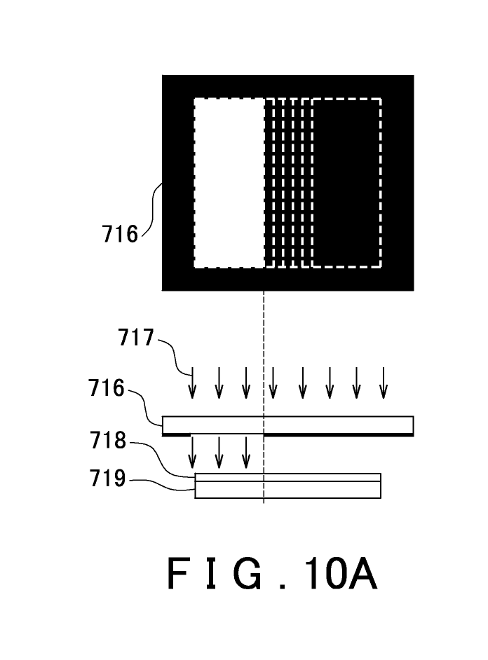

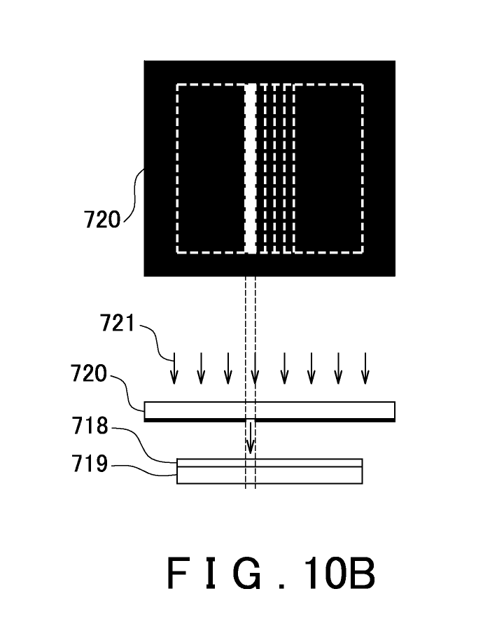

FIG. 10A is a diagram for describing the exposure of the first region 701. FIG. 10B is a diagram for describing the exposure of the narrow rectangular region 703 adjacent to the first region 701. Prior to the exposure, the glass substrate 719 is coated with an orienting agent using a spin coater and dried appropriately to form the orientation film 718. The appropriately dried orientation film 718 is exposed using a proximity technique by a UV polarized light exposure device while using a mask.

First as shown in FIG. 10A, a mask 716 with an open left side corresponding to the first region 701 is used to perform exposure with polarized light 717 having a vibrational direction of −45°. Next, as shown in FIG. 10B, a mask 720 with an opening corresponding to the narrow rectangular region 703 and adjacent to the right of the mask 716 is used to perform exposure with polarized light 721 having a vibrational direction of −30°. After this, a mask with an opening corresponding to the narrow rectangular region 704 and adjacent to the right of the mask 720 is used to perform exposure with polarized light having a vibrational direction of −15°. In the same way, a mask with an opening corresponding to the narrow rectangular region 705 and adjacent to the right of the previous mask is used to perform exposure with polarized light having a vibrational direction of 0°. A mask with an opening corresponding to the narrow rectangular region 706 and adjacent to the right of the previous mask is used to perform exposure with polarized light having a vibrational direction of 15°. A mask with an opening corresponding to the narrow rectangular region 707 and adjacent to the right of the previous mask is used to perform exposure with polarized light having a vibrational direction of 30°. Finally, a mask with an open right side corresponding to the second region 702 is used to perform exposure with polarized light having a vibrational direction of 45°. In this way, the left side of the orientation film 718 corresponding to the first region 701 has a restraining force in a −45° direction with respect to the liquid crystal molecules, and the right side of the orientation film 718 corresponding to the second region 702 has a restraining force in a 45° direction with respect to the liquid crystal molecules. Also, the orientation film 718 has five regions corresponding to the narrow rectangular regions 703 to 707 of the buffer region 790 between the first region 701 and the second region 702, and these five regions have restraining forces in directions that sequentially change in steps of 15°.

The glass substrate 719 on which the orientation film 718 is formed is coated with a photopolymerizable liquid crystal composition using a spin coater. The liquid crystal molecules in the photopolymerizable liquid crystal composition are arranged in prescribed directions according to the restraining force of the orientation film. Specifically, the liquid crystal molecules are arranged in directions of −45°, −30°, −15°, 0°, 15°, 30°, and 45° from the first region 701 through the buffer region 790 to the second region 702. Finally, the liquid crystal film is hardened by UV rays. The resulting liquid crystal filter includes liquid crystal molecules that have different arrangement directions in each of a plurality of regions on the glass substrate 719. In this example, among the seven regions including the first region 701 and the second region 702, adjacent regions each have arrangement directions that differ from each other by an angle of 15°, and therefore, based on the experimental results of Table 1, linear defects are not visible at these interfaces.

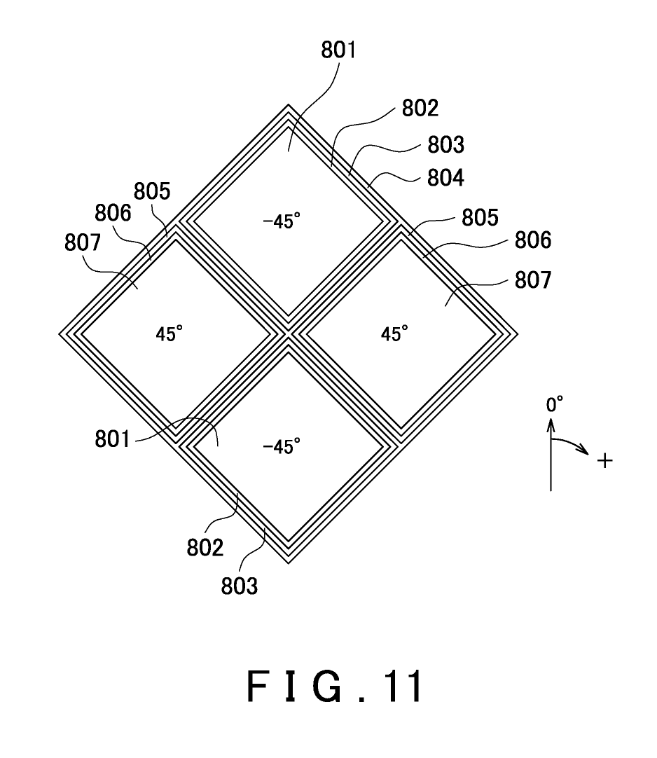

The following describes a detailed configuration where the liquid crystal filter is used as an optical low-pass filter. FIG. 11 shows an exemplary configuration of an optical low-pass filter in which the liquid crystal molecule arrangement direction changes in a stepped manner. If the optical low-pass filter is used in an image capturing apparatus such as a digital camera, a lattice pattern is formed by arranging two types of rectangular regions with different liquid crystal molecule arrangement directions two-dimensionally in an alternating and repeating manner, according to the pixel arrangement of the image capturing elements. In particular, if the pixels of the image capturing elements are square pixels, a checkerboard pattern is formed in which the rectangular regions are square regions. If the square pixels of the image capturing elements are arranged in a horizontal direction and a vertical direction, the checkerboard pattern of the liquid crystal filter is arranged at an angle rotated by 45°, as shown in FIG. 11. Here, the arrangement directions of the liquid crystal molecules are −45° and 45°. The length of each edge of each square region is no greater than approximately 1 mm, although this length can change depending on the pitch of the pixels of the image capturing elements and the specifications of the optical low-pass filter.

When the optical low-pass filter has this checkerboard pattern, the buffer region formed of narrow rectangles described above is expanded in two dimensions. Specifically, a plurality of small square regions are formed in the buffer region, and each small region has an arrangement direction that differs by 15° or less from the arrangement direction of each of the adjacent regions. For example, as shown in FIG. 11, a small region 802 with an arrangement direction of −30° and a small region 803 with an arrangement direction of −15° may be disposed in the stated order from the interface with the first region 801 having an arrangement direction of −45°. Furthermore, a small region 806 with an arrangement direction of 30° and a small region 805 with an arrangement direction of 15° may be disposed in the stated order from the interface with the second region 807 having an arrangement direction of 45°. A small region 804 with an arrangement direction of 0° is disposed between the small region 803 and the small region 805. By configuring the buffer region in this way, linear defects are not visible at the interface between the first region 801 with an arrangement direction of −45° and the second region 807 with an arrangement direction of 45°.

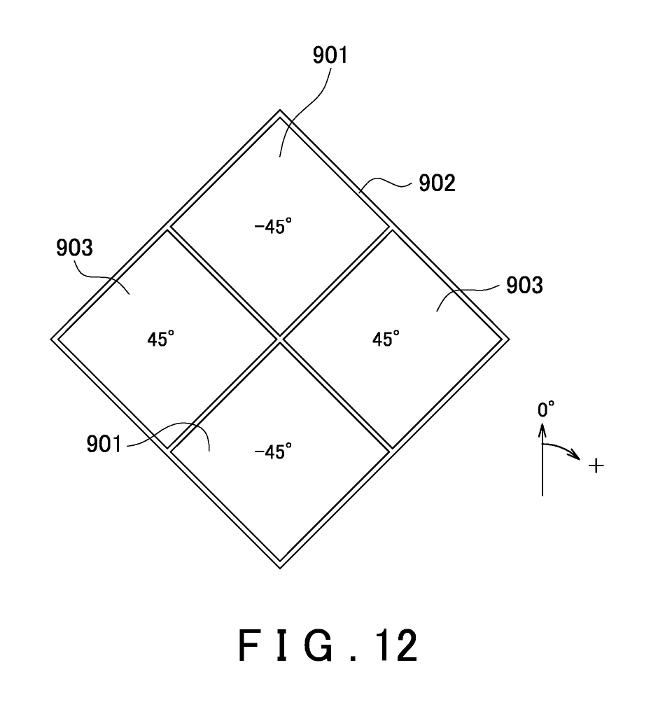

FIG. 12 shows a configuration of an optical low-pass filter in which the liquid crystal molecule arrangement direction changes continuously. The first region 901 with an arrangement direction of −45° and the second region 903 with an arrangement direction of 45° are arranged in the same manner as the first region 801 with an arrangement direction of −45° and the second region 807 with an arrangement direction of 45° in FIG. 11. A buffer region 902 is disposed between the first region 901 and the second region 903. In the buffer region 902, the liquid crystal molecule arrangement direction changes continuously from −45° to 45°. With this configuration, linear defects are not visible at the interface between the first region 901 with an arrangement direction of −45° and the second region 903 with an arrangement direction of 45°.

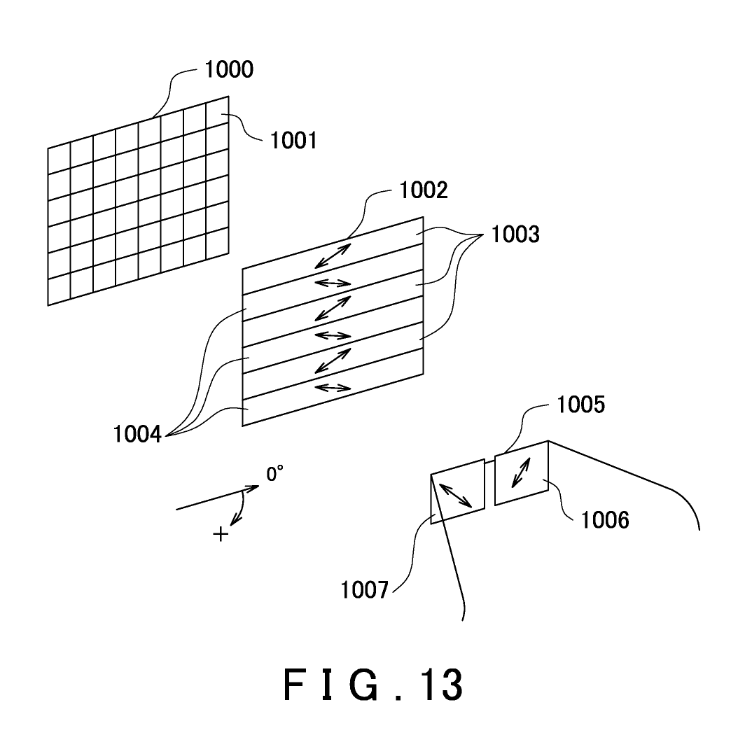

As an example that is not an optical low-pass filter, the liquid crystal filter can be the retardation film of a liquid crystal stereoscopic image display apparatus. The following describes an example of the liquid crystal filter as the retardation film. FIG. 13 is a schematic view showing a configuration of a liquid crystal stereoscopic image display apparatus.

A retardation film 1002 having horizontal stripe regions is disposed on the front of an LCD panel 1000, and an observer can wear glasses 1005 with polarizing plates to view three-dimensional images. The LCD panel 1000 outputs images for the right eye and images for the left eye, and the retardation film 1002 and glasses 1005 transmit the left-eye images to the left eye and the right-eye images to the right eye.

The retardation film 1002 is formed by the liquid crystal filter described above. The retardation film 1002 has stripe regions that extend horizontally, and the width of each stripe region is equal to the vertical length of a pixel 1001. Among the stripe regions, each odd-numbered stripe region 1003 in order from the top has a liquid crystal molecule arrangement direction of −22.5° and each even-numbered stripe region 1004 in order from the top has a liquid crystal molecule arrangement direction of 22.5°. Here, the arrangement direction is defined such that a direction directly right in the horizontal direction of the screen is 0° and a clockwise direction corresponds to positive angles.

The retardation film 1002 is disposed on or near the LCD panel 1000. The stripe regions 1003 and 1004 of the retardation film 1002 are positioned to each overlap with one horizontal row of pixels 1001 of the LCD panel 1000.

The glasses 1005 are formed by polarizing plates. A polarizing plate 1006 that transmits polarized light with a vibrational direction of −45° is provided in the right lens, and a polarizing plate 1007 that transmits polarized light with a vibrational direction of 45° is provided in the left lens.

The LCD panel 1000 is divided into two pixel groups for displaying the images for the two eyes. One pixel group displays the right-eye images and the other pixel group displays the left-eye images. Specifically, the pixels 1001 are arranged in a grid, in which, from the top, odd-numbered rows of pixels form one group and even-numbered rows of pixels form the other group, where one horizontal row is the smallest unit. The group made of odd-numbered rows displays the right-eye images, and the group made of even-numbered rows displays the left-eye images. In FIG. 11, the LCD panel 1000 has six rows of pixels 1001, among which the first, third, and fifth rows from the top display the right-eye images and the second, fourth, and sixth rows from the top display the left-eye images.

In the LCD panel 1000, the pixels 1001 in the odd-numbered rows display the right-eye images and the pixels 1001 in the even-numbered rows display the left-eye images. Here, the LCD panel 1000 emits, as the image light, polarized light with a vibrational direction of 0°, which is to the right in the horizontal direction. The rows of pixels of the LCD panel 1000 are aligned with the stripe regions of the retardation film 1002 extending in the horizontal direction, and therefore the image light emitted from the odd-numbered rows of pixels is incident to the corresponding odd-numbered stripe regions 1003. Similarly, the image light emitted from the even-numbered rows of pixels is incident to the corresponding even-numbered stripe regions 1004.

The vibration of the polarized light emitted from the LCD panel 1000 is in the 0° direction. The arrangement direction of each region in the retardation film 1002 rotates the vibration direction to be a corresponding direction. The right-eye image light with a vibrational direction of 0° emitted from the odd-numbered pixel rows passes through the odd-numbered stripe regions 1003 with arrangement directions of −22.5° in the retardation film 1002, and is therefore output toward the observer with a vibrational direction rotated to −45°. The right-eye image light with a vibrational direction of −45° passes through the polarizing plate 1006 of the right lens but does not pass through the polarizing plate 1007 of the left lens. Similarly, the left-eye image light with a vibrational direction of 0° emitted from the even-numbered pixel rows passes through the even-numbered stripe regions 1004 with arrangement directions of 22.5° in the retardation film 1002, and is therefore output toward the observer with a vibrational direction rotated to 45°. The left-eye image light with a vibrational direction of 45° passes through the polarizing plate 1007 of the left lens but does not pass through the polarizing plate 1006 of the right lens. Accordingly, the right-eye image light is transmitted to the right eye and the left-eye image light is transmitted to the left eye, and therefore the observer can see a stereoscopic image.

In the retardation film 1002, the liquid crystal arrangement directions of adjacent regions are −22.5° and 22.5°, and therefore the arrangement direction difference is 45°. Therefore, according to the experimental results of Table 1, linear defects are slightly visible at the interfaces of the retardation film 1002. This is not a preferable state for display quality.

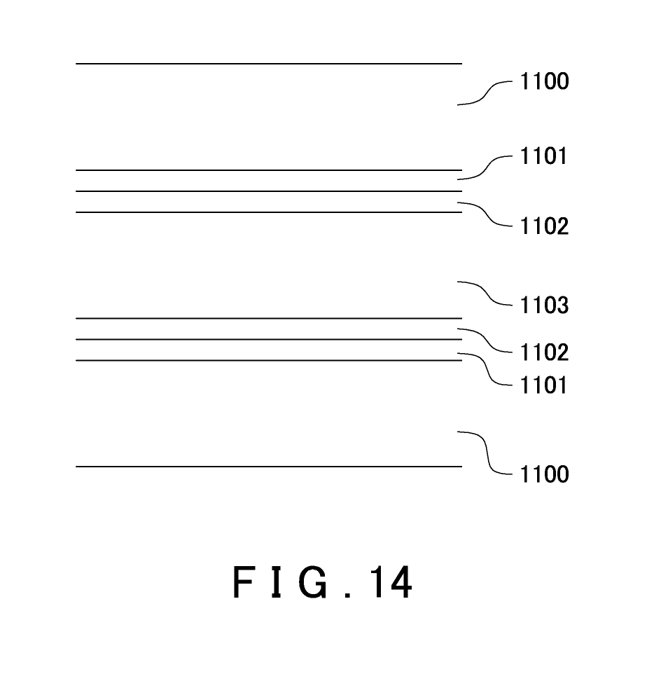

Therefore, the retardation film is formed such that difference between liquid crystal arrangement directions of adjacent regions is no greater than a prescribed angle. FIG. 14 shows a configuration of the retardation film in which the liquid crystal molecule arrangement directions change in a stepped manner. A small region 1101 with an arrangement direction of −7.5° and a small region 1102 with an arrangement direction of 7.5° are arranged between a first region 1100 with an arrangement direction of −22.5° and a second region 1103 with an arrangement direction of 22.5°. With this configuration, small regions 1101 and 1102 function as a buffer region such that the difference in liquid crystal molecule arrangement direction between adjacent regions is 15° or less, and therefore linear defects are not visible at the interface between the first region 1100 with an arrangement direction of −22.5° and the second region 1103 with an arrangement direction of 22.5°.

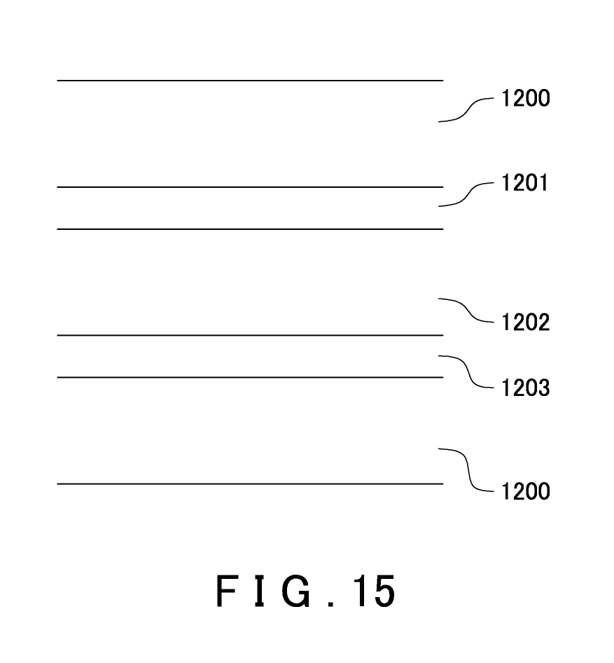

FIG. 15 shows a configuration of a retardation film in which the liquid crystal molecule arrangement direction changes continuously. Here, buffer regions 1201 and 1203 are disposed between a first region 1200 with an arrangement direction of −22.5° and a second region 1202 with an arrangement direction of 22.5°. In the buffer regions 1201 and 1203, the liquid crystal molecule arrangement direction changes continuously from −22.5° to 22.5° or from 22.5° to −22.5°. With this configuration, linear defects are not visible at the interface between the first region 1200 with an arrangement direction of −22.5° and the second region 1202 with an arrangement direction of 22.5°.

While the embodiments of the present invention have been described, the technical scope of the invention is not limited to the above described embodiments. It is apparent to persons skilled in the art that various alterations and improvements can be added to the above-described embodiments. It is also apparent from the scope of the claims that the embodiments added with such alterations or improvements can be included in the technical scope of the invention.

What is claimed is:

1. A liquid crystal filter comprising:
a first region that includes liquid crystals arranged in a first direction;
a second region that includes liquid crystals arranged in a second direction, which is different from the first direction; and
a buffer region that is disposed between the first region and the second region, and includes liquid crystals arranged in an intermediate direction between the first direction and the second direction.

2. The liquid crystal filter according to claim 1, wherein
the liquid crystals of the buffer region are arranged in a direction that continuously changes from the first direction to the second direction, from an interface with the first region to an interface with the second region.

3. The liquid crystal filter according to claim 2, wherein
the change has a rate of change that is not constant.

4. The liquid crystal filter according to claim 1, wherein
the buffer region is divided into a plurality of small regions between the first region and the second region, and the liquid crystals of the buffer region are arranged in predetermined directions that change gradually from the first direction to the second direction by changing at each small region, from the first region to the second region.

5. The liquid crystal filter according to claim 4, wherein
a difference in liquid crystal arrangement direction between each pair of adjacent small regions is 15° or less.

6. The liquid crystal filter according to claim 4, wherein
widths of the small regions in a direction from the first region to the second region are not constant.

7. The liquid crystal filter according to claim 1, wherein
a plurality of the first regions and a plurality of the second regions are arranged in the liquid crystal filter as narrow rectangles.

8. The liquid crystal filter according to claim 1, wherein
a plurality of the first regions and a plurality of the second regions are arranged in the liquid crystal filter in a grid.

9. The liquid crystal filter according to claim 1, wherein
the first direction and the second direction are orthogonal to each other.

10. A retardation film that is the liquid crystal filter according to claim 1.

11. An optical low-pass filter that is the liquid crystal filter according to claim 1.
